(19) United States
(12) Patent Application Publication
(10) Pub. No.: US 2010/0260482 A1
(43) Pub. Date: Oct. 14, 2010

(54) Generating a Synchronized Audio-Textual Description of a Video Recording Event

(76) Inventor: Yossi Zoor, Binyamina (IL)

Correspondence Address: The Law Office of Michael E. Kondoudis, 888 16th Street, N.W., Suite 800, Washington, DC, 20006, US

(21) Appl. No.: 12/423,033

(22) Filed: Apr. 14, 2009

(51) Int. Cl. H04N 7/00

(52) U.S. Cl. 386/96; 386/E05.001

(57) ABSTRACT

A data processing system and a computer implemented method for generating a synchronized audio-textual description of a video recording of an event. The data processing system comprises an audio-textual description device arranged to record an audio-textual description of the event simultaneously with and contextually relating to a playback of the video recording; and a synchronization module arranged to generate a common temporal scale for the video recording and the audio-textual description.

### BACKGROUND

1. Technical Field

The present invention relates to the field of synchronization, and more particularly, to synchronization of an event description.

2. Discussion of Related Art

There is a need, in respect to different kinds of events, to accompany their recording with some audio, textual or combined commentary or transcription. However, handling an event recording with a description is cumbersome.

### BRIEF SUMMARY

Embodiments of the present invention provide a data processing system for generating a synchronized audio-textual description of a video recording of an event. The data processing system comprises an audio-textual description device arranged to record an audio-textual description of the event simultaneously with and contextually relating to a playback of the video recording; and a synchronization module arranged to generate a common temporal scale for the video recording and the audio-textual description.

Embodiments of the present invention provide a computer implemented method of generating a synchronized audio-textual description relating to a video recording of an event. The computer implemented method comprises recording an audio-textual description of the event simultaneously with and contextually relating to a playback of the video recording; and generating a common temporal scale for the video recording and the audio-textual description.

Embodiments of the present invention provide a data processing system for generating a synchronized transcription relating to an event. The data processing system comprises: a video recorder arranged to generate a video recording of the event; an audio-textual description device arranged to record a transcription of the event; a synchronization module; and a control unit. The synchronization module is arranged to generate a common temporal scale for the video recording and the transcription. The control unit is arranged to generate a combined recording comprising the video recording and the transcription presented with the common temporal scale.

Accordingly, according to an aspect of the present invention, the audio-textual description may comprise a transcription.

### BRIEF DESCRIPTION OF THE DRAWINGS

For a better understanding of the invention and to show how the same may be carried into effect, reference will now be made, purely by way of example, to the accompanying drawings in which like numerals designate corresponding elements or sections throughout.

The present invention will be more readily understood from the detailed description of embodiments thereof made in conjunction with the accompanying drawings of which:

FIG. 1 is a high level schematic block diagram of a data processing system for generating a synchronized audio-textual description of a video recording of an event, according to some embodiments of the invention;

FIG. 2 is a high level schematic block diagram of a data processing system for generating a synchronized audio-textual description of an event, according to some embodiments of the invention;

FIG. 3 is a high level schematic flowchart demonstrating various configurations of the data processing system, according to some embodiments of the invention; and

FIG. 4 is a high level schematic flowchart illustrating a computer implemented method of generating a synchronized audio-textual description relating to a video recording of an event, according to some embodiments of the invention.

### DETAILED DESCRIPTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

For a better understanding of the invention, the usages of the term “audio-textual description” of an event is defined in the present disclosure as a textual and/or audio description relating to an event, such as a transcription of a meeting or a script of the event (textual descriptions), a synchronization of a film or commentary relating to a sports event (audio descriptions) or combinations thereof.

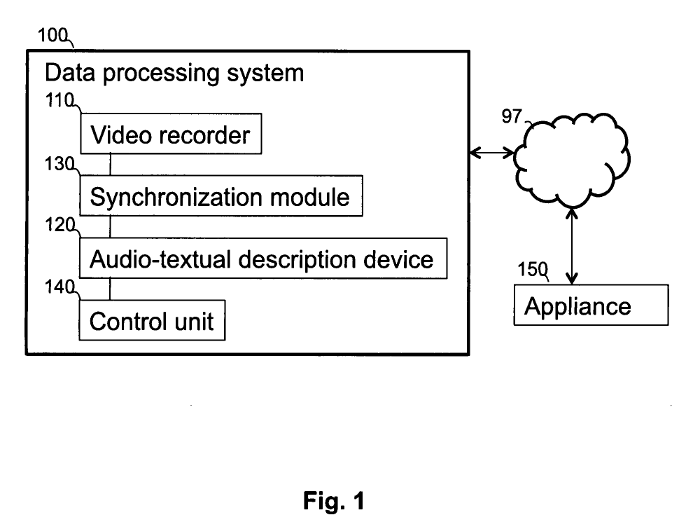

FIG. 1 is a high level schematic block diagram of a data processing system 100 for generating a synchronized audio-textual description of a video recording of an event, according to some embodiments of the invention. Data processing system 100 comprises a video recorder 110 arranged to generate a video recording of the event, an audio-textual description device 120 arranged to record an audio-textual description of the event simultaneously with and contextually relating to a playback of the video recording; and a synchronization module 130 arranged to generate a common temporal scale for the video recording and the audio-textual description. Video recorder 110, audio-textual description device 120, and synchronization module 130 are interconnected. The common temporal scale is utilized to contextually correlate the audio-textual description and the video recording and allow referring to the video recording via text and/or time related points in the audio-textual description such as specific words or sounds. For example, the audio-textual description may comprise a transcription of the event or commentary relating to the event. The video recording may be referred to via words in the transcription.

According to some embodiments of the invention, the audio-textual description may be generated in real time in respect to the event, in proximity or remotely from the event. The audio-textual description may be recorded simultaneously with the playback of the video recording, without prior preparation.

According to some embodiments of the invention, synchronization module 130 may be further arranged to generate a common temporal scale for the video recording and the audio-textual description substantially immediately after the event. Synchronization module 130 may be arranged to allow real time transcription of the event or commentary relating to the event. Synchronization module 130 may be further arranged to analyze the audio-textual description in relation to the video recording, e.g., identify certain parts, allow tagging of the audio-textual description, include some extent of editing and so forth.

According to some embodiments of the invention, data processing system 100 may further comprise a control unit 140 arranged to generate a combined recording comprising the video recording and the audio-textual description presented with the common temporal scale. The integrated recording may be delivered as an end product to a customer, or may be played back simultaneously to the event as an annotated video recording.

According to some embodiments of the invention, data processing system 100 may be integrated within a personal recorder, allowing transcription of self recorded notices. Data processing system 100 may be connected via a communication link 97 to an appliance 150, e.g., a personal computer, a personal digital assistant, a cell phone etc. Self recorded notices may then be automatically integrated within predefined programs such as a word processor, a digital calendar etc.

According to some embodiments of the invention, data processing system 100 may be arranged to enable presenting the video recording from a point identified by a corresponding point of the audio-textual description. Identifying the point in the video recording is carried out utilizing the common temporal scale and relying on their contextual correlation. For example, in case of the audio-textual description being a transcription, the video recording may be presented at a point corresponding to a specified word in the transcription.

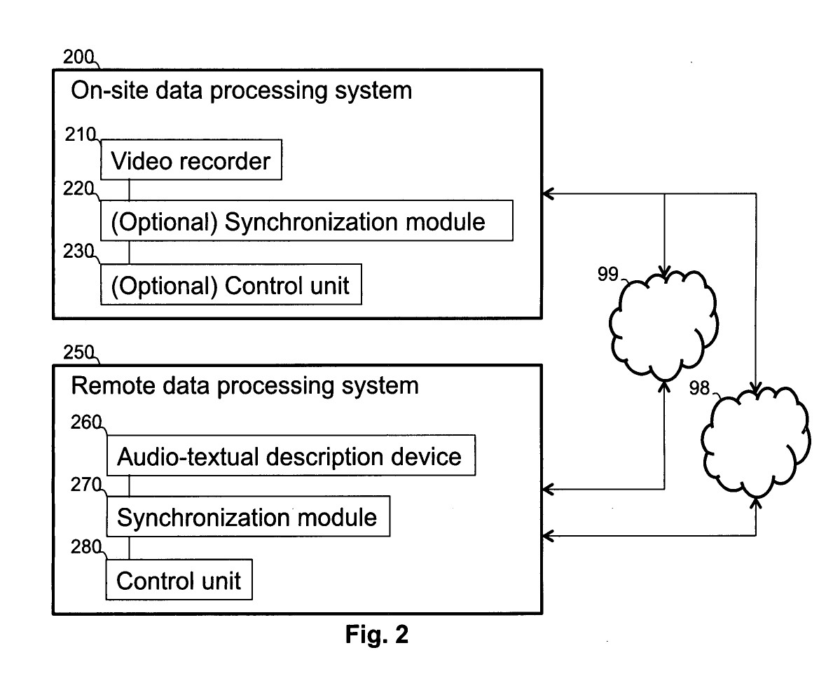

FIG. 2 is a high level schematic block diagram of a data processing system for generating a synchronized audio-textual description of an event, according to some embodiments of the invention. The data processing system comprise an on-site data processing system 200 and a remote data processing system 250 connected via a communication link 99. On-site data processing system 200 may comprise a video recorder 210 for recording the event, while remote data processing system 250 may comprise an audio-textual description device 260 arranged to record an audio-textual description of the video recording simultaneously with and contextually relating to a playback of the video recording. Remote data processing system 250 may further comprise a synchronization module 270 arranged to generate a common temporal scale for the video recording and the audio-textual description. The common temporal scale is utilized to contextually correlate the audio-textual description and the video recording and allow referring to the video recording via text and/or time related points in the audio-textual description such as specific words or sounds. For example, the audio-textual description may comprise a transcription of the event or commentary relating to the event, and remote data processing system 250 may supply on-site data processing system 200 with a remotely processed transcription of the event. The video recording may be referred to via words in the transcription.

According to some embodiments of the invention, remote data processing system 250 may further comprise a control unit 280 arranged to generate a combined recording comprising the video recording and the audio-textual description presented with the common temporal scale. The integrated recording may be delivered to on-site data processing system 200 via communication link 99. Alternatively or complementarily, on-site data processing system 200 may comprise a synchronization module 220 and/or a control unit 230 carrying out the processing of the audio-textual description and the video recording (e.g., combining or analyzing them).

According to some embodiments of the invention, either control unit 280 or control unit 230 may further comprise modules for real time speech recognition for facilitating either audio-textual description or analysis of a manually prepared audio-textual description.

According to some embodiments of the invention, synchronization module 270 may comprise a learning system arranged to mathematically or statistically analyze the generation of audio-textual description that facilitates the synchronization of the audio-textual description with the video recording. The learning system may comprise sampling a marker in the audio-textual description (for example, a cursor position in a text editor) every predefined period and relating the sampled marker to the time stamp of the ongoing video recording or event. Using marker sampling, the learning system may compare the progress of the audio-textual description in respect to the video recording or event, derive various statistics relating thereto and improve the synchronized product. The learning system may derive a typing speed from the marker samplings and used the typing speed to improve synchronization. The learning system may serve to facilitate and improve synchronizing the audio-textual description with an event on the basis of statistical analysis of former synchronizations.

According to some embodiments of the invention, the audio-textual description may comprise a manually prepared transcription. The audio-textual description may be carried out with any platform allowing audio-textual description, e.g., a transcriber may transcribe a video transmitted event using a word processor. The transcription may then be synchronized and attached to the video recording of the event via the word processor, and integrated within it.

According to some embodiments of the invention, communication link 99 may comprise a telephone network, allowing a user to transmit an audio content and receive a simultaneous or delayed transcription of the audio content via another communication link 98, e.g., the Internet.

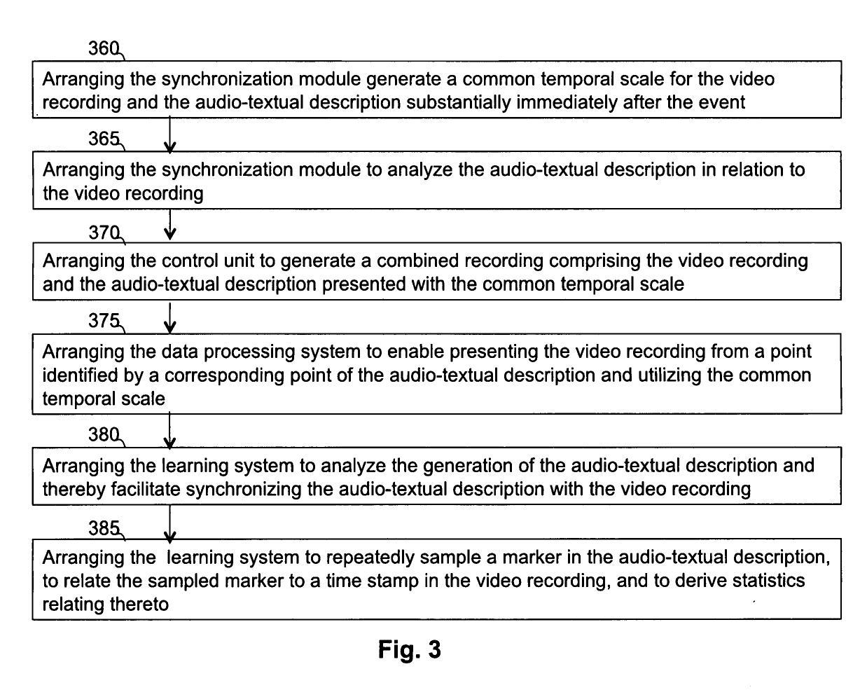

FIG. 3 is a high level schematic flowchart demonstrating various configurations of the data processing system, according to some embodiments of the invention. The flowchart summarizes some of the afore mentioned arrangement of the data processing system and its components. The flowchart comprises the stages: Arranging synchronization module 220 and 130 to generate a common temporal scale for the video recording and the audio-textual description substantially immediately after the event (stage 360); arranging synchronization module 220 and 130 to analyze the audio-textual description in relation to the video recording (stage 365); arranging control unit 280 and 140 to generate a combined recording comprising the video recording and the audio-textual description presented with the common temporal scale (stage 370); arranging data processing system 100 (or on-site data processing system 200 and remote data processing system 250) to enable presenting the video recording from a point identified by a corresponding point of the audio-textual description and utilizing the common temporal scale (stage 375); arranging the learning system to analyze the generation of the audio-textual description and thereby facilitate synchronizing the audio-textual description with the video recording (stage 380); and arranging the learning system to repeatedly sample a marker in the audio-textual description, to relate the sampled marker to a time stamp in the video recording, and to derive statistics relating thereto (stage 385).

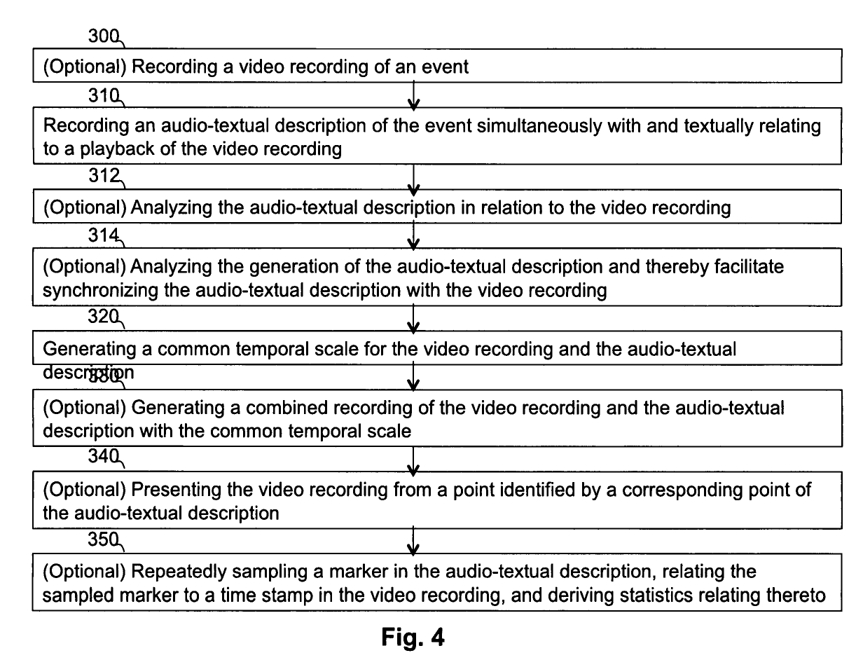

FIG. 4 is a high level schematic flowchart illustrating a computer implemented method of generating a synchronized audio-textual description relating to a video recording of an event, according to some embodiments of the invention. The computer implemented method comprises the stages: recording an audio-textual description of the event simultaneously with and contextually relating to a playback of the video recording (stage 310); and generating a common temporal scale for the video recording and the audio-textual description (stage 320).

According to some embodiments of the invention, the computer implemented method further comprises recording the video recording of the event (stage 300).

According to some embodiments of the invention, the computer implemented method further comprises analyzing the audio-textual description in relation to the video recording (stage 312); and analyzing the generation of the audio-textual description and thereby facilitate synchronizing the audio-textual description with the video recording (stage 314).

According to some embodiments of the invention, the computer implemented method further comprises generating a combined recording comprising the video recording and the audio-textual description presented with the common temporal scale (stage 330).

According to some embodiments of the invention, the audio-textual description may comprise a transcription.

According to some embodiments of the invention, recording an audio-textual description (stage 310) and generating a common temporal scale (stage 320) are carried out substantially immediately in respect to the event, i.e. in real time or shortly after the event. According to some embodiments of the invention, the computer implemented method may further comprise transmitting either the video recording, the audio-textual description or both via a communication link from a recording site to a description site and back.

According to some embodiments of the invention, the computer implemented method may further comprise presenting the video recording from a point identified by a corresponding point of the audio-textual description (stage 340). Identifying the point in the video recording is carried out utilizing the common temporal scale. For example, in case of the audio-textual description being a transcription, the video recording may be presented at a point corresponding to a specified word in the transcription.

According to some embodiments of the invention, the computer implemented method may further comprise improving synchronization between the audio-textual description and the video recording by repeatedly sampling a marker in the audio-textual description, relating the sampled marker to a time stamp in the video recording, and deriving statistics relating thereto (stage 350).

According to some embodiments of the invention, the data processing systems and computer implemented methods may comprise a revolutionary way to handle protocols, allowing a continuous and transparent switching between the protocol and the real event, searching both simultaneously and co-processing them.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. A data processing system for generating a synchronized audio-textual description of a video recording of an event, the data processing system comprising:
an audio-textual description device arranged to record an audio-textual description of the event simultaneously with and contextually relating to a playback of the video recording; and
a synchronization module arranged to generate a common temporal scale for the video recording and the audio-textual description,
wherein the common temporal scale is utilized to contextually correlate the audio-textual description and the video recording.

2. The data processing system of claim 1, wherein the audio-textual description comprises a transcription.

3. The data processing system of claim 1, wherein the synchronization module is arranged to generate a common temporal scale for the video recording and the audio-textual description substantially immediately after the event.

4. The data processing system of claim 1, wherein the synchronization module is arranged to analyze the audio-textual description in relation to the video recording.

5. The data processing system of claim 1, further comprising a control unit arranged to generate a combined recording comprising the video recording and the audio-textual description presented with the common temporal scale.

6. The data processing system of claim 1, wherein the data processing system is further arranged to enable presenting the video recording from a point identified by a corresponding point of the audio-textual description, wherein identifying the point in the video recording is carried out utilizing the common temporal scale.

7. The data processing system of claim 1, wherein the synchronization module comprises a learning system arranged to analyze the generation of the audio-textual description and thereby facilitate synchronizing the audio-textual description with the video recording.

8. The data processing system of claim 7, wherein the learning system is arranged to repeatedly sample a marker in the audio-textual description, to relate the sampled marker to a time stamp in the video recording, and to derive statistics relating thereto.

9. A computer implemented method of generating a synchronized audio-textual description relating to a video recording of an event, the computer implemented method comprising:
recording an audio-textual description of the event simultaneously with and contextually relating to a playback of the video recording; and
generating a common temporal scale for the video recording and the audio-textual description,
wherein the common temporal scale is utilized to contextually correlate the audio-textual description and the video recording.

10. The computer implemented method of claim 9, further comprising recording the video recording of the event.

11. The computer implemented method of claim 9, wherein the audio-textual description comprises a transcription.

12. The computer implemented method of claim 9, wherein the recording an audio-textual description and the generating a common temporal scale are carried out substantially immediately in respect to the event.

13. The computer implemented method of claim 9, further comprising generating a combined recording comprising the video recording and the audio-textual description presented with the common temporal scale.

14. The computer implemented method of claim 9, further comprising presenting the video recording from a point identified by a corresponding point of the audio-textual description, wherein identifying the point in the video recording is carried out utilizing the common temporal scale.

15. The computer implemented method of claim 9, further comprising improving synchronization between the audio-textual description and the video recording by repeatedly sampling a marker in the audio-textual description, relating the sampled marker to a time stamp in the video recording, and deriving statistics relating thereto.

16. A data processing system for generating a synchronized transcription relating to an event, the data processing system comprising:
a video recorder arranged to generate a video recording of the event;
an audio-textual description device arranged to record a transcription of the event;
a synchronization module; and
a control unit,
wherein the synchronization module is arranged to generate a common temporal scale for the video recording and the transcription,
wherein the control unit is arranged to generate a combined recording comprising the video recording and the transcription presented with the common temporal scale, and
wherein the common temporal scale is utilized to contextually correlate the audio-textual description and the video recording and to allow reference to the video recording via the audio-textual description.

17. The data processing system of claim 16, wherein the synchronization module comprises a learning system arranged to statistically analyze the generation of the audio-textual description and thereby facilitate synchronizing the audio-textual description with the event.

18. The data processing system of claim 16, further arranged to enable presenting the video recording from a point identified by a corresponding point of the audio-textual description, wherein identifying the point in the video recording is carried out utilizing the common temporal scale.
